(19) United States
(12) Patent Application Publication
(10) Pub. No.: US 2015/0001118 A1
(43) Pub. Date: Jan. 1, 2015

(54) APPLICATION OF DESIGNS TO PORTION OF FOOD CONTAINER

(71) Applicant: Golden Aluminum, Inc., Fort Lupton, CO (US)

(72) Inventors: Mark Selepack, Longmont, CO (US); Leland Lorentzen, Erie, CO (US)

(21) Appl. No.: 14/486,356

(22) Filed: Sep. 15, 2014

Related U.S. Application Data
(62) Division of application No. 13/621,516, filed on Sep. 17, 2012, now abandoned.
(60) Provisional application No. 61/535,903, filed on Sep. 16, 2011.
(60) Provisional application No. 61/550,759, filed on Oct. 24, 2011.
(60) Provisional application No. 61/551,825, filed on Oct. 26, 2011.

(51) Int. Cl. G09F 3/02

(52) U.S. Cl. CPC G09F 3/02; G09F 2003/0208; G09F 2003/0272
USPC 206/459.5

(57) ABSTRACT

The present disclosure describes a process for applying a design to a sheet metal for use in a portion of a container, for example a cap or an end of a food container. Embodiments provide for applying a multi-color design in a single printing step to a sheet of metal to create a printed metal sheet that can then be rolled into a printed coil or cut to length. The printed metal sheet can then be cut pressed into can ends or caps. The ends or caps with the multi-color design can then be used to manufacture containers, such as a beverage container.

### CROSS REFERENCE TO RELATED APPLICATIONS

This present application claims priority as a divisional application of U.S. patent application Ser. No. 13/621,516, filed Sep. 17, 2012, which claims the benefit of U.S. Provisional Application No. 61/535,903, filed Sep. 16, 2011, U.S. Provisional Application No. 61/550,759, filed Oct. 24, 2011, and U.S. Provisional Application No. 61/551,825, filed Oct. 26, 2011, all entitled “APPLICATION OF DESIGNS TO PORTION OF FOOD CONTAINER”, each of which is incorporated herein by reference in its entirety.

### FIELD

Embodiments of the present invention relate generally to applying coatings to can ends. More specifically, embodiments of the present invention relate to printing for creating designs on portions of food containers, such as can ends or caps.

### BACKGROUND

Aluminum beverage containers are generally made in two pieces, one piece forming the container sidewalls and bottom (referred to herein as “container body”) and a second piece forming a container end. Generally, the container body is fabricated by forming a cup from a circular blank aluminum sheet (i.e., body stock) and then extending and thinning the sidewalls by passing the cup through a series of dies having progressively smaller bore sizes. This process is referred to as “drawing and ironing” the container body. The ends of the container are formed from end stock and attached to the container body. The tab on the upper container end that is used to provide an opening to dispense the contents of the container is formed from tab stock.

Aluminum alloy sheet can be formed from a variety of differing processes. Commonly, the aluminum alloy is cast as an ingot, billet, or slab, such as by direct chill casting, ingot casting, belt casting, roll casting, or block casting, and subjected to further process steps, such as hot and cold rolling, homogenization, and annealing, to produce aluminum alloy sheet having suitable properties for use as body, end, or tab stock. Because body, end, and tab stock will contact foods, it is coated with a food grade coating to prevent metal ions from the container migrating into the food stored in the container, better preserve the food contents, improve the contents taste characteristics, improve corrosion resistance, and improve formability and appearance of the metal.

The production of can ends typically begins by providing some end stock in the form of a coil. When manufacturing the coil for end stock, a coating may be applied to a top surface and a bottom surface of the sheet that is rolled into the coil. Current coil coating methods do not allow more elaborate designs on a roll coated sheet. Such methods are limited to the use of a single color and coating type per side.

The process for adding additional designs to can ends involves first providing a coil of bare metal or pretreated aluminum coil stock. The end stock is then cut into individual sheets in an operation called “cut to length.” The individual sheets are cut to a specific length and then each sheet is stacked one on top of the other. The sheets are then moved to a coating operation in which a single sheet is taken from the stack and coated one side only. The sheet is then placed on its side and held in place in a wire rack and passed through a coating oven. At the exit end of the oven, the sheets again are stacked one on top of another. The stack is returned to the entry end, and the other side of the sheet is coated. This operation continues until the final color and design pattern is achieved. This cyclic operation can require as many as 6 passes through the coater head and ovens before the final color and design pattern are produced. This can be a time consuming process based on the number of steps required to apply intricate and high-resolution designs.

After the sheets have been coated fully, they are stacked and sent to a press. The press will take a sheet from the top of a stack, and stamp it to generate an end or cap. Each sheet may generate a number of ends/caps depending on the size of the sheet and the size of the press. The ends/caps are then applied to a body at the final filler. The end may be a twist cap in which case it is twisted onto the body of a container. The end may be an end that is fixed, such as by a seamer, to an end of a container body.

This background section is included merely to provide some context to the subject matter described in this application. Although specific problems and issues have been identified, the claims are not limited to solving any particular problem or issue identified in this section. As those with skill in the art will appreciate, the claimed embodiments may be useful for solving these and other problems.

### SUMMARY

These and other needs are addressed by the various aspects, embodiments, and/or configurations disclosed herein. The disclosure is directed generally to printing sheet metal used for manufacturing portions of a can such as a can end.

A process can include the steps:

printing a multi-color design on a first surface of sheet metal to generate a printed sheet metal, wherein the printing applies two or more different colors to create a multi-color design; and

drying and/or curing the printed multi-color design on the printed sheet metal; and.

thereafter, forming the printed multi-color design into a cap or can end or a beverage container.

A plurality of multi-color designs can be printed to the first surface of the sheet metal during a single run to generate the printed sheet metal. Each of the individual designs can be printed so that when can ends or caps are generated from the printed sheet metal, each individual design decorates a single can end or cap. The ability to print the multi-color designs in one step can allow the sheet metal to remain in a single continuous piece that can then be rolled back up into a printed coil or cut to length for further processing. This can eliminate the need to process sheets of metal through a number of separate steps as is necessary in conventional processes.

The printed sheet metal can include multiple multi-color designs, each of which is arranged to decorate a can end or cap. In addition, the printed sheet metal can also include registration marks that index the multi-color designs to assist in aligning the printed sheet metal with a press for generating ends or caps. The registration marks may be provided for each individual multi-color design with each registration mark aligned with a press prior to pressing the printed sheet metal to generate can ends or caps.

The press may include additional features for creating a three dimensional (3D) relief on portions of the multi-color design. In other words, the printed design may include areas that are intended to have some additional 3D relief. As part of the process of pressing can ends or caps from the printed sheet metal, the additional 3D relief may be applied to those areas. It should be appreciated that the application of the 3D relief may occur using a press that is separate from the press used to create the can ends or caps.

The aspects, embodiments, and configurations can provide a number of advantages depending on the particular application. Compared to conventional processes, the present embodiments can allow for multi-color designs to be applied efficiently in a single step, rather than the multiple steps of coating and drying/curing necessary with conventional processes. Also, because the process of printing the designs on the sheet metal can be performed in a single step, more colors, intricate designs, and high-resolution designs can be applied since the additional time necessary for printing the additional colors or intricate designs is not as great as would be necessary using conventional processes. The multi-color design may be applied to a continuous sheet, which can allow the printed sheet metal to be rolled back up into a coil for easy transportation to a shell press.

These and other advantages will be apparent from the disclosure contained herein.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “multi-color designs” refers to designs that include more than color. The colors may be red, green, blue, yellow, black, white, orange, violet, and mixtures and blends thereof. The colors can be monochromatic or polychromatic. The colors may be different hues or shades of a common color.

The preceding is a simplified summary to provide an understanding of some aspects, embodiments, and/or configurations. This summary is neither an extensive nor exhaustive overview of the invention and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the aspects, embodiments, and/or configurations disclosed herein. These drawings, together with the description, explain the principles of the aspects, embodiments, and/or configurations. The drawings simply illustrate preferred and alternative examples of how the aspects, embodiments, and/or configurations can be made and used and are not to be construed as limiting the aspects, embodiments, and/or configurations to only the illustrated and described examples. Further features and advantages will become apparent from the following, more detailed, description of the various aspects, embodiments, and/or configurations, as illustrated by the drawings referenced below.

FIG. 1 depicts printing multi-color designs onto a continuous sheet metal that is then rolled into a printed coil;

FIG. 2 depicts printing multi-color designs and registration marks onto a sheet metal, according to an embodiment;

FIG. 3 depicts a flow chart for a process of printing multi-color designs onto a sheet metal to be used in manufacturing a portion of a can;

FIG. 4A depicts a multi-color design before it is part of a can end;

FIG. 4B depicts a multi-color design as part of a can end that includes additional texture on the design;

FIG. 5 depicts pressing printed sheet metal that includes multi-color designs to generate can ends, according to an embodiment;

FIG. 6A depicts a flow chart for a process of generating can ends from a sheet metal that includes multi-color designs;

FIG. 6B depicts a flow chart for a process of generating caps from a sheet metal that includes multi-color designs;

FIG. 7 depicts a flow chart for generating a final food container that includes an end with a multi-color design;

FIG. 8 depicts a flow chart for printing a coil;

FIG. 9 depicts a flow chart for printing a coil; and

FIG. 10 depicts a flow chart for printing can ends.

### DETAILED DESCRIPTION

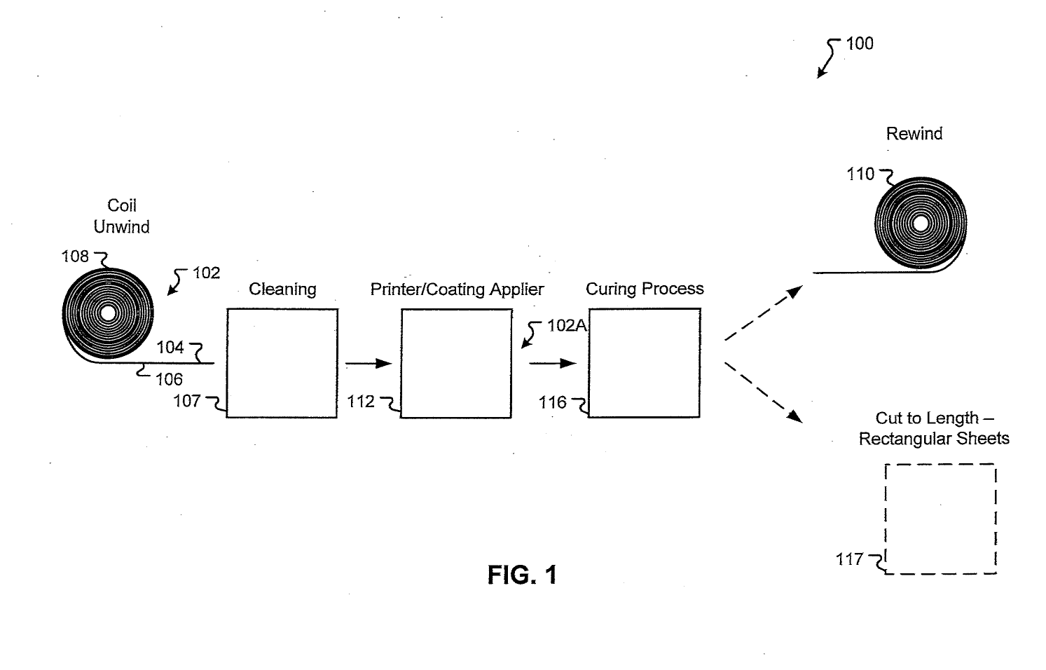

FIG. 1 illustrates a system 100 and method for printing a design, such as a multi-color design, on a sheet metal 102 according to an embodiment. The sheet metal 102 can be used to generate any portion of a container, e.g., beverage container, food container, and container for storing other objects or materials. For example, sheet metal 102 may be body stock, end stock, or tab stock. Sheet metal 102 includes a first surface 104 (e.g., a top surface) and a second surface 106 (e.g., a bottom surface). Sheet metal 102 is provided in the form of a coil 108 that is unwound to print a design on a surface of the sheet metal 102. Sheet metal 102 may have a coating or primer on one or more of the first and second surfaces 104, 106 or be free of a coating or primer.

After the sheet metal 102 is unwound it is passed through a cleaning process 107 that removes any dust or debris from the surfaces 104 and 106 of the sheet metal. The cleaning process 107 ensures that the surfaces 104 and 106 are clean before the sheet metal is printed by printer 112. Cleaning process 107 can include the use of different types of equipment and materials for removing dust, grease, and debris from the surfaces of the sheet metal. In embodiments, cleaning process 107 includes the use of one or more of pump, sprayers, rollers, brushes, and/or blowers. The process 107 can use different solutions including in some embodiments, degreasers, solvents, detergents, surfactants, and/or other chemicals for cleaning the surfaces of the sheet metal 102.

As shown in FIG. 1, printer 112 prints a design onto a selected surface of the cleaned sheet metal. Optionally, printer 112 prints a design or coating on both the top surface 104 and the bottom surface 106. The printer 112 used to print ink or paint onto sheet metal 102 may be any printer designed for metal decorating. For example, printers manufactured by INX International Ink Co. from Schaumburg, Ill., are suitable for printing designs on sheet metal 102. Printers from INX are capable of applying a number of standard AP series inks including inks known as Retortable, NoVar, Phosphorescent, Wet Look, Fluorescent, and LoVOC inks. As can be appreciated, the printer 112 may be capable of being controlled by software being run on a computer system. In embodiments, the designs for printing on the sheet metal 102 may be digital designs that are entered into a computer system connected to printers 112 and/or 114. The present disclosure is not limited to the particular printer or ink used and can include the use of any suitable printer or ink for metal decorating. As described in greater detail below, the printed design may be printed on the sheet metal 102 for use in generating a decorated can end, such as a beverage can. In other embodiments, the sheet metal 102 is used in generating tabs and the printed design is applied in order to generate decorated tabs for use in containers, e.g., beverage container, food container, and container for storing other objects or materials. In still other embodiments, the sheet metal 102 may be used in generating bodies for containers. For example, the sheet metal 102 may be body stock and the printed design applied to the sheet metal 102 to generate a decorated bottom of a beverage container.

If necessary, after the printing of the designs, sheet metal 102 is passed through curing process 116 to dry or cure the ink or paint used in printing of the designs. In embodiments, component 116 is an oven or furnace that dries or cures the ink or paint. In one other configuration, the component 116 exposes the printed designs to other stimuli, such as chemicals, ions, light, or other stimuli for drying or curing the ink used in printing the designs on the sheet metal 102.

After a multi-color design has been applied to the top surface 104 of sheet metal 102 and dried and/or cured, it is rolled into a printed coil 110, or cut to length in rectangular sheets 117 and stacked, for further processing, such as pressing.

In other embodiments, the printed sheet metal is rewound by a rewinding process into a printed coil 110, instead of being cut into individual rectangular sheets. As can be appreciated, rolling the printed sheet metal 102A provides some advantages in transporting the sheet metal to other operations for generating portions of a container including making can ends for beverage containers.

In the cut to length process 117, printed sheet metal 102A is cut into individual rectangular sheets. The rectangular sheets can be stacked and used, for example, to make caps for bottles. The equipment used in process 117 can be conventional cut to length equipment. Advantageously, the cut to length rectangular sheets are not passed again to the printer/coater applier 112 and curing process 116 as the selected multiple colors and design were applied substantially simultaneously in one pass through the process 100.

Compared with conventional processes which require multiple coating steps and multiple drying/curing steps to generate a multi-color design, system 100 provides a more efficient way of applying multi-color designs to sheet metal 102 for use in creating a portion of a container e.g., beverage container, food container, and container for storing other objects or materials.

In embodiments, sheet metal 102 is made from any suitable alloy such as alloys of aluminum, iron, copper, and zinc. As some examples, sheet metal 102 may be made from a 1000 series-based alloy, a 3000 series-based alloy, and a 5000 series-based alloy such as AA 5000 series including AA 5352, AA 5182, AA 5042, and AA 5017. It should be noted that the compositions of the alloy may vary depending on the particular application and other processing steps that will be performed. As can be appreciated, the properties of the sheet metal 102 must be within the necessary tolerances for mechanical properties and other performance characteristics necessary for its application.

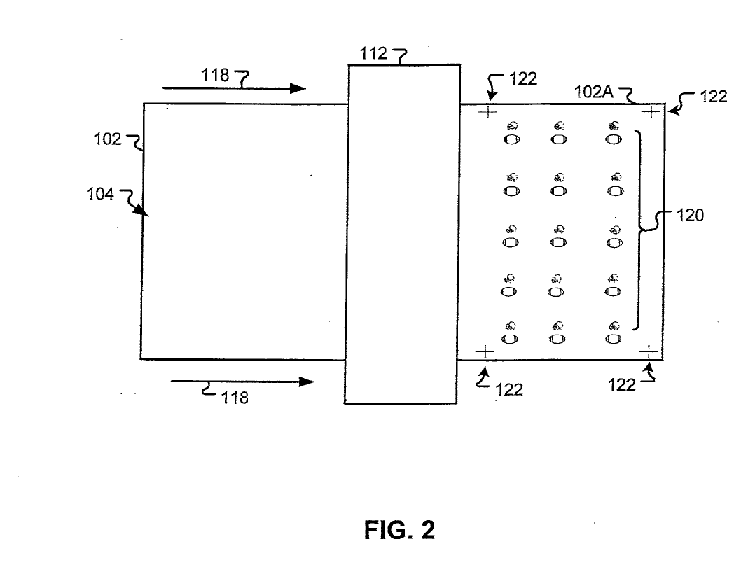

For purposes of illustration and simplicity, the following description of FIGS. 2-8 include portions that are directed to generating can ends and caps decorated with printed designs, according to an embodiment. However this is being done merely for purposes of illustration and as those with skill in the art will appreciate the present invention is not limited to can ends and caps, but may also be used to make other portions of food containers such as a body of a food container or a tab used open containers. Accordingly, the specific description below of generating can ends should not be used to limit the principles of the present invention to other applications.

FIG. 2 illustrates a top view of an embodiment of printing designs for generating decorated beverage can ends or caps. As shown in FIG. 2, sheet metal 102 is moving in the direction illustrated by arrows 118. As sheet metal 102 is moved under printer 112, the printer 112 prints a plurality of designs 120 onto the first surface 104 of sheet metal 102. The plurality of designs 120 are printed so that each of the individual designs will be included on a can end or cap. It is noted that the number of printed multi-color designs 120 and their orientation as shown in FIG. 2 are for illustration purposes only, and do not necessarily reflect the actual number or orientation. As those with skill in the art will appreciate, in those embodiments in which the printed sheet metal 102A will be used to generate can ends, the printed sheet will be sent to a shell press. Typical shell presses generate 22 or 24 beverage can ends per press. If the sheet will be used to generate can ends, the printed multi-color designs 120 may be oriented at an angle with respect to an edge of sheet metal 102 and not perfectly parallel or perpendicular as illustrated in FIG. 2.

In embodiments, printer 112 is capable of printing a plurality of intricate multi-color designs that are small enough to fit on a standard beverage can end or cap. In addition to the plurality of printed multi-color designs 120, the printer 112 may also print registration marks 122. The registration marks 122 are used to align the sheet metal 102 in subsequent pressing operations.

The printed sheet metal 102 may be cut into individual sheets or maintained as a continuous piece that is rewound into a printed coil as described above with respect to FIG. 1. The present disclosure is not limited to the use of a continuous piece but as noted above having sheet metal 102 in a continuous piece provides some advantages such as allowing the sheet metal 102 to be rolled into a printed coil for easily transporting the printed sheet metal 102A to shell press operations.

In some embodiments, prior to printing sheet metal 102, the width dimension of sheet metal 102 is selected based on the shell press that will eventually be used to generate the beverage can ends. Each shell press can accommodate only a certain range of widths. For example, some shell presses may require that sheet metal 102 have a width of from about 57 inches to about 60 inches wide. Other shell presses require that sheet metal 102 have a width of from about 60 inches to about 68 inches. The width of sheet metal 102 is not necessarily limited to any particular width; however, it should be selected so that it is compatible within the shell press that will be used to generate the beverage can ends.

As indicated above, printer 112 is capable of printing high-resolution, intricate, and multi-color designs that are capable of fitting on a conventional can end or cap. As can be appreciated, can ends or caps have a number of standard dimensions. In embodiments, the individual printed designs that make up the plurality of designs 120 are able to each fit in the area provided by a top surface of a standard can end or cap. The dimensions of the can end or cap are considered when programming printer 112 to print the plurality of printed designs 120. For example in the case of can ends, each of the printed designs making up the plurality of designs 120 can be sized to fit on a standard can end, for example a #202, #204, #206, #209, or #211 beverage can end. Other standard dimensions are possible depending on the particular size of the can end or cap.

The registration marks 122, printed by printer 112, are used to align sheet metal 102 during subsequent pressing operations. The registration marks 122 provide a way for a press that is used for generating the can ends to align the press with the plurality of printed designs 120 in order to ensure that after stamping, each individual design is on a single can end or cap. In some embodiments, the registration marks 122 may be printed onto sheet metal 102 before the printed designs 120 are printed on sheet metal 102. In these embodiments, the marks 122 would then be used by printer 112 to ensure that the plurality of printed designs 120 are printed onto the surface 104 of sheet metal 102 in a known spatial position and orientation so that subsequent pressing operations are aligned correctly.

Although the registration marks shown in FIG. 2 are printed by printer 112, in other embodiments the registration marks may be generated by a different printer or by some other means such as engraving, notching or other operation that creates a way of indexing the sheet metal 102. In some embodiments, instead of, or in addition to registration marks 122, sheet metal 102 includes holes that are used to maintain sheet metal 102 in alignment through subsequent operations.

The registration marks 122 are shown in FIG. 2 on the four corners of an area that includes the plurality of printed designs 120. The registration marks 122 allow the sheet metal 102 to be indexed when pressed. If there should be some jamming or other mechanical failure that causes the pressing operation to stop, the registration marks can be used to move another portion of sheet metal 102 into the proper position for stamping and the stamping operation resumed. In other embodiments, in addition to having the registration marks 122 at the four corners of an area, each printed design of the plurality of printed designs can have registration marks that allow a stamp in a press to be aligned with the individual printed design.

The registration marks 122 are generated to correspond to the particular press that will be used to generate the can ends. That is, the positions of the registration marks 122, such as their position from a right edge of sheet metal 102, left edge of sheet metal 102, the next registration mark, and/or the last registration mark is determined based on the particular press that will be used in subsequent pressing operations. Stated another way, different presses use differing sets of registration marks 122, that differ from one another in any respect, such as number, spatial position, and/or spatial orientation of marks 122. The registration marks 122 ensure that the sheet metal 102 and the plurality of printed designs are indexed and aligned with the presses in a subsequent pressing operation.

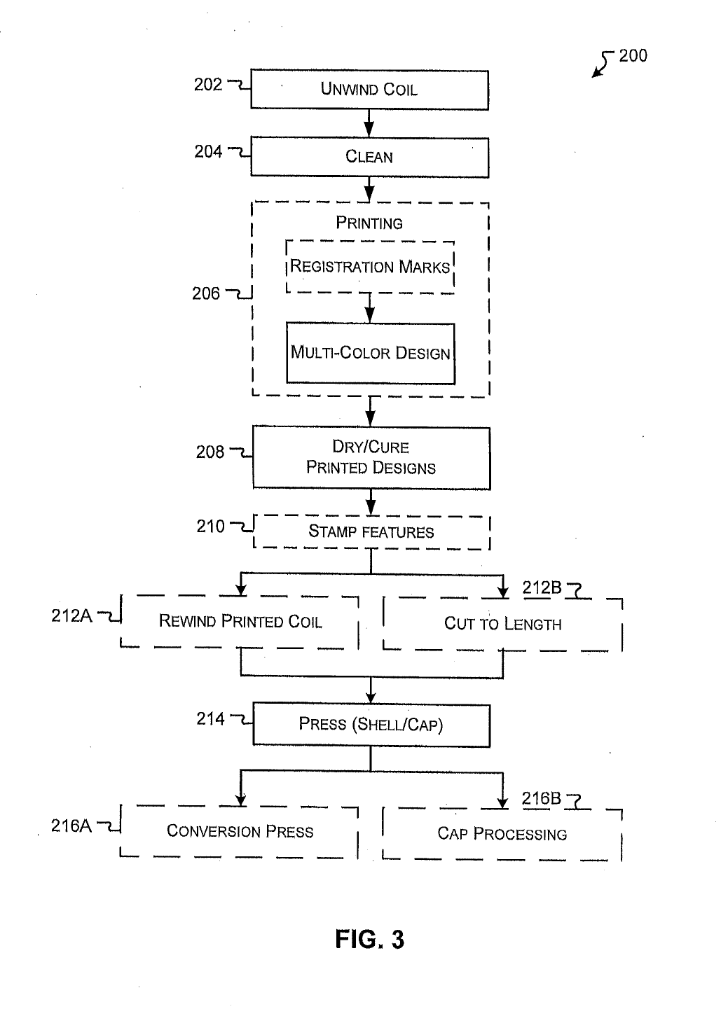

FIG. 3 depicts an embodiment of a flow diagram 200 illustrating a variation of the process described above that is used to generate a plurality of printed designs on a sheet metal 102 (FIG. 1) for use in manufacturing beverage can ends or caps. It is noted that the particular steps of flow 200 do not have to be performed in the order shown in FIG. 3. The steps may be performed in different order or substantially simultaneously, in some embodiments.

Flow 200 begins at step 202 where a coil of sheet metal 102 (FIG. 1), such as coil 108 (FIG. 1), is unwound. At step 204, the sheet metal is passed through a cleaning step (discussed above) where materials on the surface of the sheet metal, including dust, debris, other particles, grease, a protective layer, are removed to allow ink or paints applied in a subsequent printing step to adhere to the sheet metal 102. In some embodiments, step 204 may also involve conditioning the surface of sheet metal to improve the quality of the printed designs applied in a later printing step.

A printing step 206 follows step 204. The printing step may involve a number of sub steps one of which includes an optional sub-step of printing registration marks on the surface of the sheet metal. It is noted that although the registration marks are described as printed, in other embodiments they may, instead of or in addition to being printed, be scribed, etched, engraved, cut, and/or notched into the sheet metal. Step 206 also involves the sub-step of printing a plurality of designs on the sheet metal 102. It is noted that in some embodiments the sub-steps of printing registration marks and printing the multi-color designs are performed substantially at the same time by a common machine. In other embodiments, the sub-steps of printing registration marks and multi-color designs are done at different times by different machines. Step 206 may be performed for example by a printer 112 (FIGS. 1 and 2) designed for metal decoration. In embodiments, the designs printed on the sheet metal 102 are multi-color designs that can be printed in a single printing step without the need to apply a first color, dry or cure the first color, apply a second color and then dry or cure the second color. As noted above with respect to FIGS. 1 and 2, the multi-color designs are sized to fit on the top surface of a standard beverage can end or cap.

At step 208, the printed design is dried or cured by a curing process. Depending on the particular inks or paints used in step 206, drying or curing of the printed design may involve simply allowing the printed designs to be exposed to air for a predetermined period of time. In other embodiments, step 208 may involve applying some other stimulus such as heat, gas flow, chemical compound(s), ions, light, and/or other radiation.

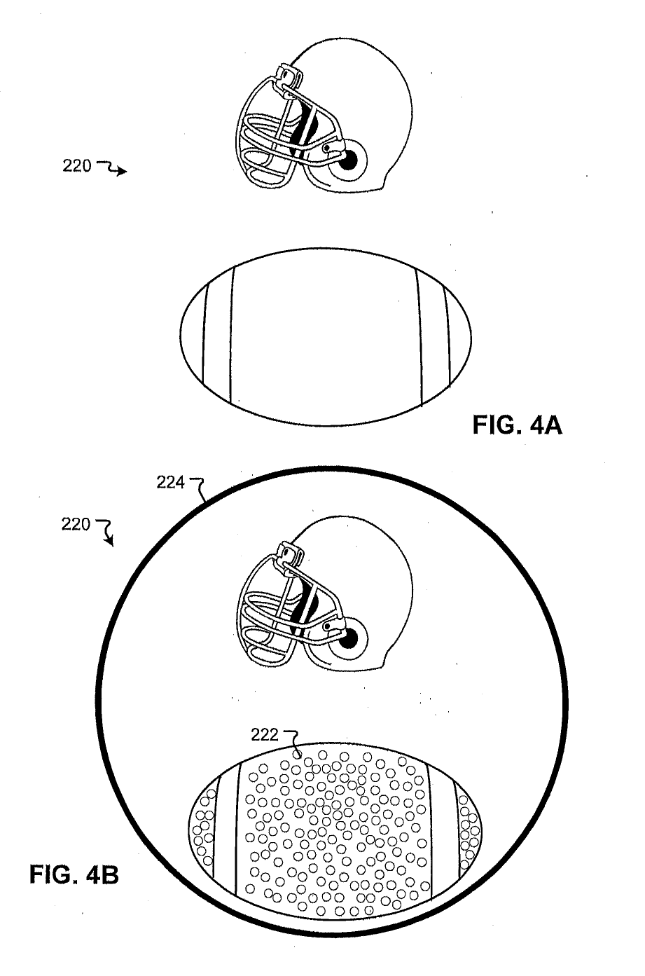

Flow 200 includes an optional step 210 in which three-dimensional (3D) relief is added, such as by stamping or pressing (in a shell or cap press), onto the printed design. The 3D relief can add texture or other features to enhance the printed designs printed at step 206. FIGS. 4A and 4B illustrate an example of adding 3D relief onto a printed design. FIG. 4A illustrates a printed design that includes two areas one illustrating a football helmet and the other illustrating a football. FIG. 4A illustrates the printed design before any 3D relief has been added to the design. FIG. 4B illustrates the printed design after 3D relief 222 (dimples or plural raised or elevated areas) have been applied to one portion of the design, namely the football to provide a 3D relief. FIG. 4B illustrates that the addition of the 3D relief 222 has occurred during a pressing step by a shell press that in addition to adding the 3D relief 222 also creates a can end 224. However, the present invention is not limited thereto.

As can be appreciated, step 210 involves the use of a press or other device with a die that can apply 3D relief 222 to a printed design. Step 210 can selectively apply the 3D relief to some areas of the printed design and not others. As shown in FIG. 4B, 3D relief 222 is applied to the football portion of design 220 but not the helmet. Thus, step 210 can be performed to selectively apply 3D relief to some portions of a printed design and not others.

In some embodiments, the 3D relief 222 can be applied to a sheet metal 102 prior to step 206 of printing the printed design. That is, instead of having the stamped features applied on top of the printed design, the stamped features may be applied to a sheet metal first, and the design printed on top of the stamped features. In these embodiments, registration marks can be used to align the stamped features during step 206 to ensure that the printed design is aligned with the stamped features so that the stamped features enhance the desired portion of the printed design.

After optional step 210, flow includes optional step 212A in which the printed sheet 102A metal is rewound into a printed coil, such as coil 110 (FIG. 1) or optional step 212B where the printed sheet is cut to length to generate individual rectangular sheets. As previously indicated, the printed sheet metal 102A may in some embodiments be cut into individual sheets to be used in generating caps. Performing step 212A to generate a printed coil 110, allows the printed sheet metal 102A to be more easily transported to pressing steps, such as a shell press, for generating a beverage can end.

After optional steps 212A or 212B, the printed sheet metal 102A (either in sheets or in a printed coil) are processed to a pressing step 214. Depending on the desired final product (e.g., a beverage can end or a cap) pressing step 214 may involve the use of different presses. For example, if the desired final product is a beverage can end, then the press used in step 214 will be a shell press.

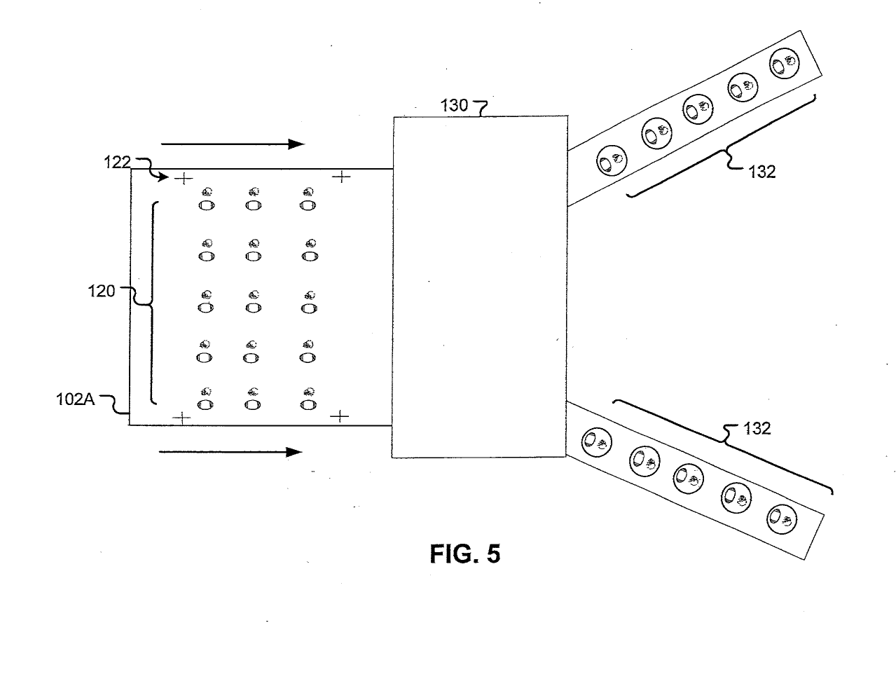

FIG. 5 depicts one embodiment of a pressing step that may be performed as part of step 214 in which printed sheet metal 102A, with a plurality of printed designs 120, is processed through a shell press to generate a plurality of beverage can ends 132, consistent with an embodiment of the present invention. The printed sheet metal 102A includes registration marks 122 that allow the printed sheet metal 102A to be aligned with shell press 130. It is noted that the number of printed designs 120 and their orientation shown in FIG. 5 are drawn for illustration purposes only and do not necessarily reflect the actual number or orientation that would be used in a typical shell press.

Although the registration marks 122 are shown in FIG. 5 as printed, in other embodiments the registration marks may be replaced or supplemented by other means such as engraving, notching or other means that creates a way of indexing the printed sheet metal 102A. In some embodiments, instead of, or in addition to registration marks 122, sheet metal 102 includes holes that are used to maintain sheet metal 102 in alignment for the stamping step.

Once the printed sheet metal 102A is properly aligned with respect to shell press 130, using the registration marks 122, the printed sheet metal 102A is stamped to generate a plurality of decorated beverage can ends 132. As shown in FIG. 5, each of the printed designs that make up the plurality of printed designs 120 are included in one of the plurality of decorated can ends 132. In embodiments, shell press 130 can generate 22 or 24 beverage can ends per pressing step depending on the width of the sheet metal. Shell press 130 may generate more than 5,500 shells per minute in some embodiments. Shell presses that are suitable for use as shell press 130 are manufactured by Formatec Tooling Systems of Dayton, Ohio. The plurality of decorated can ends 132, once generated by shell press 130, are sent to other operations such as rivet forming and scoring operations.

In some embodiments, shell press 130 can accommodate two pieces of printed sheet metal 102A at the same time. In these embodiments, printed sheet metal 102A may be of a narrower width so that two piece of printed sheet metal 102A can be placed side-by-side and stamped using shell press 130 to generate the plurality of decorated beverage ends 132.

Although FIG. 5 illustrates that each individual printed design, of the plurality of printed designs 120, is included on one decorated can end of the plurality of can ends 132, in other embodiments, printed sheet metal 102A may include one or more larger, printed designs. In these embodiments, the plurality of decorated can ends 132 can each include a portion of a printed design. This may be useful in situations where a beverage company has a promotion where a portion of a design is included on a decorated can end, and a collection of cans can be placed next to each other to visualize the entire design.

Referring back to FIG. 3, after pressing step 214, the pressed can ends or caps can be sent to other optional processes 216A and 216B. For example, if at step 214, beverage can ends are generated then the further processing 216A may involve sending the pressed can ends to a conversion press. If, however, at step 214 caps are generated then the step 216B may involve additional processing of the caps.

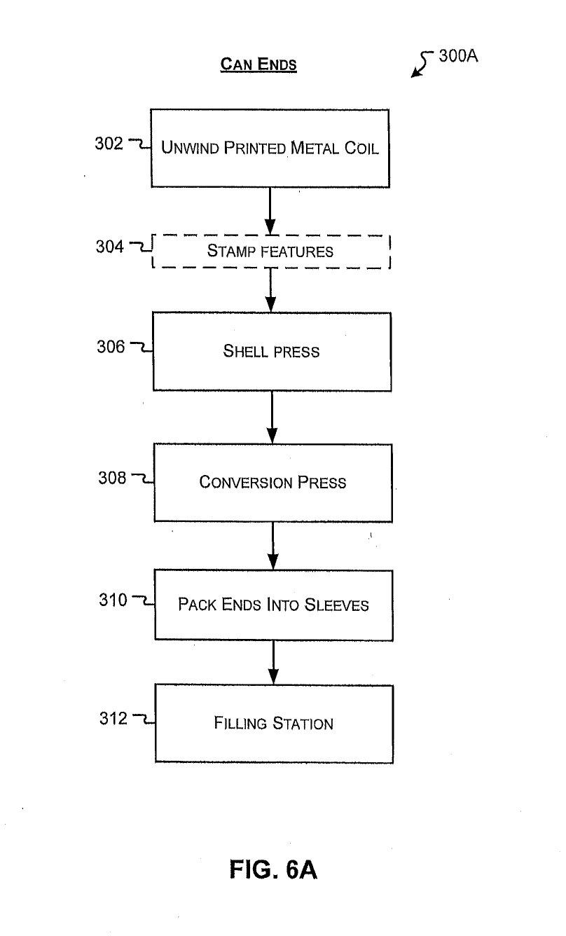

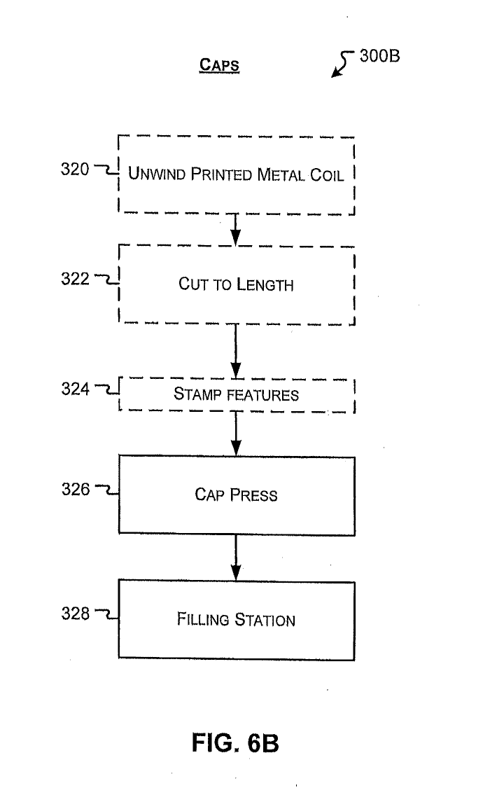

FIGS. 6A and 6B depicts an embodiment of flow diagrams 300A and 300B illustrating variations of the processes described above that are used to generate a plurality of decorated beverage can ends or caps from a printed sheet metal 102A (FIGS. 1 and 5). It is noted that the particular steps of flows 300A or 300B do not have to be performed in the order shown in FIGS. 6A and 6B. The steps may be performed in different order or substantially simultaneously, in some embodiments.

Beginning with FIG. 6A, flow 300A begins at step 302 where a coil of printed sheet metal 102A (FIGS. 1 and 5), such as coil 110 (FIG. 1), is unwound. The printed sheet metal 102A includes a plurality of printed designs. The printed sheet metal 102A is manufactured using the process described above where the plurality of printed designs are efficiently applied in a single step, rather than the multiple steps of coating and drying/curing necessary with conventional processes. The printed designs on the printed sheet metal can be multi-color with high resolution features.

Flow 300A includes an optional step 304 where 3D relief can be applied to the printed sheet metal such as by stamping or pressing. Step 304 is optional because it may not be desired to have the 3D relief, or in some embodiments, the 3D relief may already have been applied to the printed designs. It is noted that in some embodiments step 304 may be performed in other steps of flow 300, such as during the pressing step 306 described below.

At step 306, the printed sheet metal 102A is pressed to create a plurality of decorated can ends, such as can ends 132 (FIG. 5). Step 306 is performed, typically, using the standard shell press. As noted above, in some embodiments additional 3D relief may be added during the pressing step 306. In these embodiments, the shell press may, in addition to including the necessary dies to generate the can ends, include dies for adding the 3D relief to the can ends. The 3D relief applied to the can ends may be any type of texture or pattern that is desired.

After step 306, the can ends generated at 306 are sent to a conversion press at 308 where the can ends are scored and tabs are added to the can ends. Step 308 is performed by conversion presses that are well-known in the industry. After step 308, the can ends with the tabs are packed at 310 into sleeves and at 312 are sent to filling stations for use on final beverage cans. As can be appreciated, the description above of flow 300 is for illustrative purposes only and for simplicity not all of the actual steps used in creating can ends are described. However, in actual operation, embodiments would include those additional operations which may include one or more of curling the edge of the can end, scoring the can end, creating rivets on the can ends, and/or adding a sealing compound to the can end.

Referring now to FIG. 6B, flow 300B begins at optional step 320 where a coil of printed sheet metal 102A (FIGS. 1 and 5), such as coil 110 (FIG. 1), is unwound. Optional step 320 is followed by optional step 322 where the printed sheet metal is cut to length into rectangular sheets. Step 320 and 322 are optional because in some embodiments the printed sheet metal may already be in the form of rectangular sheets. For example, during the process of printing the multi-color designs, the sheet metal may have been cut into sheets.

Flow 300B includes an optional step 324 where 3D relief can be applied, such as by stamping or pressing, to the printed sheet metal. Step 324 is optional because it may not be desired to have the 3D relief or in some embodiments, the 3D relief may already have been applied to the printed designs. It is noted that in some embodiments step 324 may be performed during or after other steps of flow 300B, such as during the pressing step 326 described below.

At step 326, the printed sheet metal 102A is pressed to create a plurality of decorated caps. Step 306 is performed, typically, using the standard cap presses for generating caps. As noted above, in some embodiments additional 3D relief may be added during the pressing step 326. In these embodiments, the cap press may, in addition to including the necessary dies to generate the caps, include dies for adding the 3D relief to the caps. The 3D relief applied to the caps may be any type of texture or pattern that is desired.

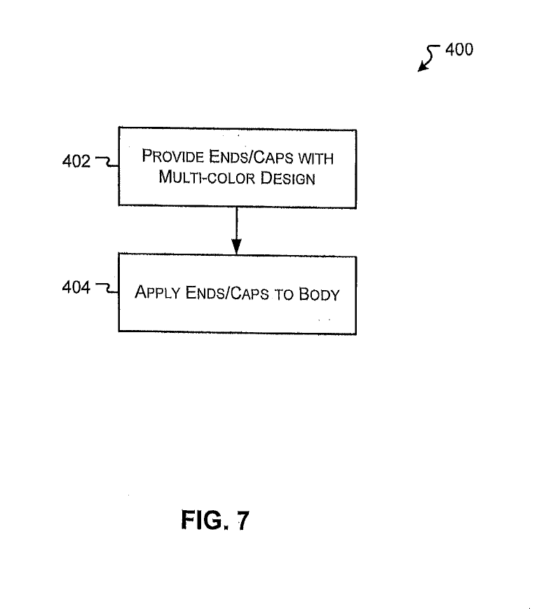

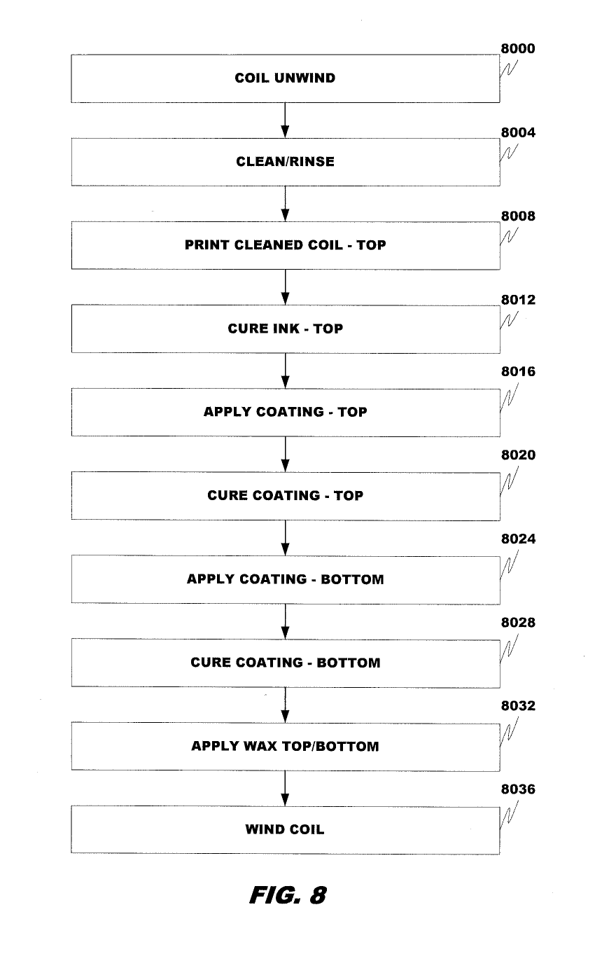

Referring now to FIG. 7, a flow 400 is depicted for generating a container that includes a container engaged with a can end or cap with a multi-color design. The flow 400 is commonly performed by a beverage manufacturer or supplier, such as a filling station. Flow 400 begins at step 402 where can ends or caps with a multi-color design are provided. The designs on the can ends or caps are printed multi-color designs that can be printed in a single printing step without the need to apply a first color, dry or cure the first color, apply a second color and then dry or cure the second color, as in conventional processes. At step 400, the can ends or caps are applied to a body to create a container that includes the can ends or caps with the multi-color design. In embodiments, the container is filled with solids or liquids before the can ends or caps are applied. For example, if the container is a beverage container, it will be filled with the beverage before the end or cap is applied to the body of the container at step 404.

A number of variations and modifications of the aspects, embodiments, and/or configurations can be used.

For example, it should be noted that although the descriptions may provide for creating can ends, the present invention is not limited thereto. In other embodiments, the present invention is used to generate any portion of a container, such as an end, body, or tab. The container can be used for any application including storage of food, beverages, or other liquids or solids. Also, it is possible for embodiments to include some features while not including others, such as performing some steps described in flows 200, 300, and 400 without performing other steps.

In another embodiment, designs are applied to converted or finished ends and not simply to sheets that are later fabricated into converted or finished ends. The designs can be applied prior to or after application of a coating, such as an EB coating, to the end. In the latter variation, a clear protective coating, such as a lacquer or varnish, is applied to protect the design. In the former variation, the coating will protect the design with the need to apply a clear coating. After the design is printed, the ink in the design is cured, such as by electron beam (“EB”), ultraviolet (“UV”), or thermal techniques. The printing and curing processes can be performed by a digital ink printer to which the converted or finished ends are fed. To remove wax and lubricants, the ends can be cleaned, such as by a chemical solution and/or ultrasonic cleansing technique, prior to printing and curing. Regardless of the process used to apply the design, the ends, after curing and optionally after application of the protective coating, are packaged and sent to the customer.

In another embodiment, designs are applied to uncoated sheet that will be later formed into converted or finished ends. As noted, application of the design prior to coating application can obviate the need to apply a clear protective coating to protect the design.

These embodiments of various design printing processes are illustrated in FIGS. 8-10.

FIG. 8 depicts the process that would be employed with an EB coating applied on top of a digitally printed design. Exemplary EB and/or ultraviolet (“UV”) curable coatings and processes for forming the coatings and aluminum alloys are discussed in copending U.S. application Ser. No. 12/401,269, filed Mar. 10, 2009 (published as US-2010-0230618-A1).

Radiation curable polymer precursors are monomeric and/or oligomeric materials, such as acrylics, methacrylates, epoxies, polyesters, polyols, glycols, silicones, urethanes, vinyl ethers, and combinations thereof which have been modified to include functional groups and optionally photoinitiators that trigger polymerization, commonly cross-linking, upon application of UV or EB radiant energy. Radiation curable polymer precursors are monomeric and/or oligimeric materials such as acrylics, acrylates, acrylic acid, alkenes, allyl amines, amides, bisphenol A diglycidylether, butadiene monoxide, carboxylates, dienes, epoxies, ethylenes, ethyleneglycol diglycidylether, fluorinated alkenes, fumaric acid and esters thereof, glycols, glycidol, itaconic acid and esters thereof, maleic anhydride, methacrylates, methacrylonitriles, methacrylic acid, polyesters, polyols, propylenes, silicones, styrenes, styrene oxide, urethanes, vinyl ethers, vinyl halides, vinylidene halides, vinylcyclohexene oxide, conducting polymers such as dimethylallyl phosphonate, organometallic compounds including metal alkoxides (such as titanates, tin alkoxides, zirconates, and alkoxides of germanium and erbium), and combinations thereof, which have been modified to include functional groups and optionally photoinitiators that trigger polymerization upon the application of ultraviolet (UV) or electron beam (EB) radiant energy. Such polymer precursors include acrylated aliphatic oligomers, acrylated aromatic oligomers, acrylated epoxy monomers, acrylated epoxy oligomers, aliphatic epoxy acrylates, aliphatic urethane acrylates, aliphatic urethane methacrylates, allyl methacrylate, amine-modified oligoether acrylates, amine-modified polyether acrylates, aromatic acid acrylate, aromatic epoxy acrylates, aromatic urethane methacrylates, butylene glycol acrylate, silanes, silicones, stearyl acrylate, cycloaliphatic epoxides, cyclohexyl methacrylate, dialkylaminoalkyl methacrylates, ethylene glycol dimethacrylate, epoxy methacrylates, epoxy soy bean acrylates, fluoroalkyl(meth)acrylates, glycidyl methacrylate, hexanediol dimethacrylate, hydroxyethyl methacrylate, hydroxypropyl methacrylate, isodecyl acrylate, isoctyl acrylate, oligoether acrylates, polybutadiene diacrylate, polyester acrylate monomers, polyester acrylate oligomers, polyethylene glycol dimethacrylate, stearyl methacylate, triethylene glycol diacetate, trimethoxysilyl propyl methacrylate, and vinyl ethers. A typical curable coating composition includes from about 30 to about 60 wt. % reactive oligomer and from about 20 to about 40 wt. % reactive monomers.

The typical polymer precursors are acrylate-based coating compositions. Such compositions typically include oligomers containing urethane groups that can be prepared to meet a wide range of cured film properties. Generally, a mixture of monofunctional (one acrylate group) and polyfunctional (more than one acrylate group) acrylates is used to optimize cured film properties and liquid coating cure speed. Compared to polyfunctional acrylates, monofunctional monomers more effectively reduce viscosity and cured film shrinkage while increasing the elasticity of the cured film. However, a high concentration of monofunctional monomer can severely reduce coating cure speed. In contrast, highly functionalized monomers increase coating cure speed and increase cured film resistance to abrasion. An exemplary coating composition is Durethane™ produced by the Coatings and Resins Group of PPG Industries, Inc.

Photoinitiators are materials which absorb UV and EB radiant energy and form reactive free radicals, cations, or anions which initiate polymerization of the monomeric and oligomeric materials. In UV curing, photoinitiators absorb light in two wavelength ranges, namely approximately 250 and 365 nm. Photoinitiators include acryloins, ketones, substituted benzoquinones, substituted polynuclear quinones, halogenated aliphatic, alicyclic and aromatic hydrocarbons, and mixtures thereof. Photoinitiators may not be necessary for use with polymeric precursors that contain functional groups that are sufficiently reactive to polymerize upon irradiation particularly with EB radiation. Examples of such polymeric precursors include acrylate compositions. In EB curing, cationically-cured compositions can require a small amount of acid producing photoinitiator. Curable coatings typically include from about 1 to about 10 wt. % of a photo initiator.

The polymer coating composition may also optionally contain additives such as dyes, pigment particles, anticorrosion agents, antioxidants, adhesion promoters, light stabilizers, lubricants, and mixtures thereof. Typically, the coating composition includes about 5 wt. % or less of other additives.

With reference to FIG. 8, the coil is unwound (step 8000), the unwound coil is cleaned and rinsed with a clean only system (step 8004), the cleaned coil is (e.g., digitally) printed with a design using an EB and/or UV curable ink on the top of the coil (step 8008), the printed (EB and/or UV curable) ink is cured (step 8012), an EB and/or UV curable coating is applied to the top (but not bottom) of the coil (step 8016), the EB and/or UV curable coating is cured (step 8020), the EB and/or UV curable coating is thereafter applied to the bottom (but not top) of the coil (step 8024), the thereafter applied EB and/or UV curable coating is cured (step 8028), wax is applied to the top and bottom of the EB and/or UV cured and coated coil (step 8032), and finally the coil is rewound (step 8036). The application of the EB and/or UV curable coating and printing can be reversed, whereby the multi-color design is printed on the EB and/or UV curable coating. In that event, a further conventional or EB and/or UV curable coating or other type of protective coating, such as a varnish protective coating, is applied.

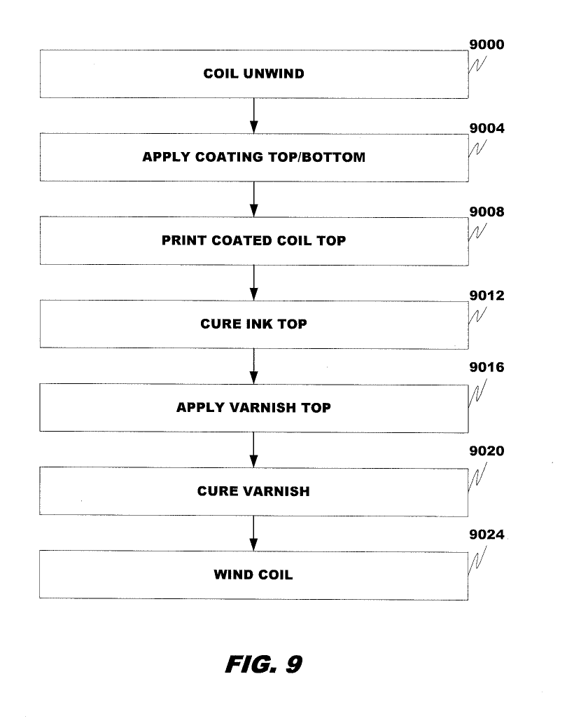

FIG. 9 depicts a process that would be employed to digitally print the design on top of the EB and/or UV curable coating. With reference to FIG. 9, the coil is unwound (step 9000), the unwound coil is coated on a normal coating line with conventional solvent or water-based coatings already qualified in the industry (step 9004), the coated coil is brought to the EB and/or UV coating and curing line (not shown), bypassing the cleaning/rinsing tanks, to form an EB and/or UV curable coating on the previously applied coating, the coated coil is (e.g., digitally) printed with a design using an EB or UV curable ink on the top of the coil and coating (step 9008), the printed (EB and/or UV curable) ink is cured (step 9012), varnish is applied to the top (but not the bottom) of the printed coil (step 9016), the varnish is cured to form a varnish protective coating (step 9020), and finally the coil is rewound (step 9024).

As can be seen in FIGS. 8-9, the EB or UV-curable ink for the design can be cured before or after application of the EB and/or UV-curable coating. In the latter case, the ink and coating and be cured substantially simultaneously. While UV curing is performed by illuminating the coating with light, EB curing is performed by exposing the coating to high-energy electrons.

Any suitable EB source may be employed, with scanning electron beam, continuous electron beam, and continuous compact electron beam EB sources being common. A typical EB source includes a high voltage supply that provides power to an electron gun assembly, positioned within an optional vacuum chamber having a foil window for passing electrons. Many coatings require a low oxygen environment during EB curing to cure or polymerize the coating. In such cases, nitrogen gas is pumped into the chamber to displace oxygen. Suitably positioned rollers positioned at the entrance and exit guide the movement of the sheet through the device.

The EB source commonly produces an electron beam of about 1,000 Kv or less, even more commonly of about 500 Kv or less, even more commonly ranging from about 50 to about 400 Kv, and even more commonly ranging from about 80 to about 300 Kv. The higher the voltage, the deeper the electrons penetrate into the coated substrate. The depth of cure for an EB coating density of about 1 g/cm³ typically ranges from about 1 to about 20 mils and even more typically from about 1.5 to about 10 mils. For scanning electron beam and continuous electron beam EB sources, the current typically is no more than about 2,000 ma, even more typically no more than about 1,500 ma, and even more commonly ranges from about 50 to about 1,000 ma.

UV curing can be performed by any suitable UV source. Typical sources include electrode, electrodeless, and xenon light sources. Electrode and electrodeless light sources commonly have a wattage/inch ranging from about 150 to about 750 to produce an irradiance of from about 5 to about 15 watts/inch² while xenon lamps commonly produce an irradiance ranging from about 1,500 to about 2,500 watts/inch².

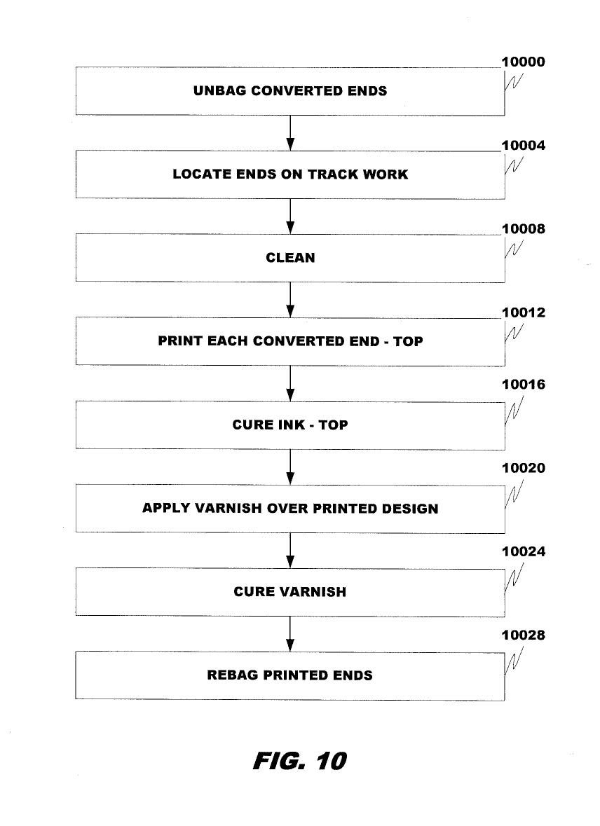

FIG. 10 depicts a process that would be employed to digitally print converted or finished ends. The converted ends are purchased or rolled and meet the final filler/customer needs. As will be appreciated, every filler does not use the exact same end, even though the ends may be in accordance with industry specifications, such as a 202 end. With reference to FIG. 10, converted ends are unbagged (step 10000), the unbagged ends are located on track work (step 10004), the located ends are cleaned (such as by an ultrasonic cleaning process to remove the wax and press oils from the located ends) (step 10008), the top of each cleaned converted end is (digitally) printed with a design using an EB or UV curable ink (step 10012), the ink is cured (step 10016), a varnish protective coating is applied over the printed design (step 10024), and finally the printed ends are re-bagged for shipping to the filler (step 10028).

As used in the above FIGS. 8-10, “EB coating” refers to an electron beam curable coating, “EB-curable ink” refers to electron beam-curable ink, and “UV-curable ink” refers to ultraviolet light-curable ink.

The present disclosure includes components, methods, processes, systems and/or apparatus substantially as depicted and described herein, including various aspects, embodiments, configurations, subcombinations and subsets thereof. Those of skill in the art will understand how to make and use the aspects, embodiments, and/or configurations after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the aspects, embodiments, and/or configurations to the form or forms disclosed herein. In the foregoing Detailed Description for example, various features are grouped together in one or more aspects, embodiments, and configurations for the purpose of streamlining the disclosure. The features of the aspects, embodiments, and configurations may be combined in alternate aspects, embodiments, and/or configurations other than those discussed above. This method of disclosure is not to be interpreted as reflecting an intention that the claimed aspects, embodiments, and/or configurations require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred aspect, embodiment, and/or configuration.

Moreover, though the present disclosure has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A food container, comprising:
an aluminum alloy sidewall;
an aluminum alloy first end; and
an aluminum alloy second end, the first and second ends being opposed to one another, wherein at least one of the first and second ends comprise a multi-colored design.

2. The container of claim 1, wherein the first end is integrally formed with the sidewall, wherein the second end is discrete from the sidewall, and wherein the multi-colored design is on the second end.

3. The container of claim 2, wherein the second end comprises a three-dimensional feature, the multi-color design being in register with the three-dimensional feature, whereby an element of the three-dimensional design is positioned in a raised area of the second end.

4. The container of claim 1, wherein the first end is integrally formed with the sidewall, wherein the second end is discrete from the sidewall, wherein the multi-colored design is on the first end, and wherein the first end comprises a three-dimensional feature, the multi-color design being in register with the three-dimensional feature, whereby an element of the three-dimensional design is positioned in a raised area of the first end.

5. The container of claim 3, wherein the second end is free of a primer between the multi-color design and the aluminum alloy in the second end.

6. The container of claim 3, wherein the second end comprises a primer between the multi-color design and the aluminum alloy in the second end.

7. The container of claim 3, wherein a protective coating is located on an exterior of the second end such that the multi-color design is positioned between the aluminum alloy in the second end and the protective coating.

8. The container of claim 3, wherein an EB and/or UV cured coating is located on the second end such that the EB and/or UV cured coating is positioned between the aluminum alloy in the second end and the multi-color design.

9. The container of claim 7, wherein the protective coating is electron beam and/or ultraviolet light curable.
